(19) United States
(12) Patent Application Publication
(10) Pub. No.: US 2025/0165029 A1
(43) Pub. Date: May 22, 2025

(54) HEADSET HAVING A DISPLAY UNIT

(71) Applicant: GEEKS LOFT INC., Seongnam-si (KR)

(72) Inventors: Scott Seongwook LEE, Suwon-si (KR); Ji In KWON, Hwaseong-si (KR); Byung Hoon KIM, Osan-si (KR)

(73) Assignee: GEEKS LOFT INC., Seongnam-si (KR)

(21) Appl. No.: 19/031,463

(22) Filed: Jan. 18, 2025

Related U.S. Application Data
(63) Continuation of application No. PCT/KR2023/020163, filed on Dec. 8, 2023.

(30) Foreign Application Priority Data
Aug. 29, 2023 (KR) 10-2023-0113317

(51) Int. Cl. G06F 1/16; H04R 1/10

(52) U.S. Cl. CPC G06F 1/1615; H04R 1/1008; H04R 2499/15

(57) ABSTRACT

A headset including a rotatable display unit according to an embodiment of the present invention may be a headband and an ear cap connected to both ends of the headband through a connection unit; a display unit mounted on a display band connected from the connection unit; and the display band may be rotatable from a first position where the display unit overlaps with the headband by axes of the connection unit to a second position located in front of a user's eye.

### CROSS-REFERENCE TO RELATED APPLICATIONS

This application is a Continuation application of International Application No. PCT/KR2023/020163, filed on Dec. 8, 2023, which is based on and claims priority to Korean Patent Application No. 10-2023-0113317, filed on Aug. 29, 2023, in the Korean Intellectual Property Office, the disclosures of which are incorporated by reference herein in their entireties.

### BACKGROUND

### 1. Field

The following disclosure relates to a headset device having a display unit.

### 2. Description of Related Art

Since the past, a device that provides an image to a user has been attempted in various forms along with a device that transmits sound. All of the conventional devices focused on the design and shape of video equipment that can implement a newly introduced visual image such as VR, AR, and XR, and once a display in the form of glass or goggles has been implemented and then a speaker has been inserted into the equipment. Nevertheless, the uniform form factor has not been established to date for various reasons.

There are two representative approaches to solve this problem, including a glass method and a goggle method.

Research on smart glass has been actively conducted from the past to the present, and there are a number of inventions that put a speaker into a smart glass device equipped with a display. However, these methods have revealed various limitations, such as durability and weighting problems, and commercialization studies have been continued to create a more user-friendly device by a smart glass method, including Google, which is a global large corporation.

Meanwhile, headgears or goggles type equipment that covers the visual field originated from VR have been actively developed. However, the device type also has problems such as accumulating fatigue due to long-term use in a visually disconnected environment from the outside, and pressing the face tightly by being mounted on the face by a band method. Nevertheless, research for constructing a general form factor has been continued in the world, including a sony that creates a game device and a meta, which concluded that these methods are desirable to implement a more developing visual image.

The voice of a market that allows the rapidly developing video technology to be mounted and transmitting vivid sounds in the form factor competition, which is developed in various ways, is increasing in the market, which wants a new type of device that does not have inconvenience to a user in the course of use.

### SUMMARY

An object according to an embodiment is to provide a headset device with a new concept that can simultaneously provide a user with an image reproduced in a display while providing a high quality sound.

An object according to an embodiment is to propose a headset device that can be worn for a long time and can effectively deliver sound and images without inconvenience in use.

Another object according to an embodiment is to propose a new structure of form factor that can be commercialized and is not difficult to use for a long time, which overcomes the problems of conventional smart glasses or goggles that have not been commercialized.

According to an embodiment of the present invention, a headset including a rotatable display unit may include: an ear cap connected to both ends of the head band and the head band through a connection unit; a display unit mounted on the display band connected from the connection unit; and the display band may be rotatable from a first position where the display unit overlaps with the head band to a second position where the display band is positioned in front of the user's eye.

According to an embodiment, the connection unit may include a click module, and the rotation may be semi-automatically performed by pressing a button of the click module positioned at the connection unit.

According to an embodiment, the connection unit may further include a mainspring, and the semi-automatic rotation may be performed by using a force that rotates by the unwind of the mainspring.

According to an embodiment, the method in which the display band returns from the second position to the first position may be manually driven.

According to an embodiment, the connection unit may include at least one of an axis extending in a third direction vertically to the button from the center of the button; a pinion gear mounted at one end of the extended axis; a mainspring mounted together at the extended axis adjacent to the pinion gear; and a spring provided to be compressible in the third direction along the axis between the button and the pinion gear.

According to an embodiment, the connection unit may further include a deceleration unit that decelerates when the display band approaches the second position after the rotation starts, and the deceleration unit may be engaged with the pinion gear.

According to an embodiment, the rotation may be performed according that the display band is extended in a direction away from the user's head.

According to an embodiment, the display band may have a structure extending from a shaft mounted on the connection unit, and the extension may be performed by vertically elevating the shaft from the connection unit when the button is pressed.

According to an embodiment, the connection unit may include a spring provided at the other end where the display band of the shaft is positioned, and the shaft may be vertically elevating by the elastic force of the spring when the button is pressed.

According to an embodiment, the connection unit may further include a vertical gear attached to the shaft; a pinion gear rotating by engaging one side with the vertical gear; and a mainspring having the same rotation axis as the pinion gear, and the rotation force of the pinion gear may be increased while the mainspring is unwound when the shaft is vertically elevating.

According to an embodiment, the connection unit may further include a deceleration unit engaged at the other side of the pinion gear, and the deceleration unit may be adjusting a falling speed when the display band is rotating motion.

A method of using a headset including a rotatable display unit according to another embodiment of the present invention, the headset ear cap connected to both ends of the head band and the head band through a connection unit; The display band may include a display unit mounted on the display band connected from the connection unit, and the display band may be rotatable from a first position where the display unit overlaps with the head band to a second position where the display band is positioned in front of the user's eye.

According to an embodiment, a headset including a rotatable display unit may wear a head band on which an ear cup is mounted and a display band overlapped on an upper end of the head, and may be driven such that the display band on which the display unit is mounted rotates to position the display in front of the eye when the display unit is used. Through this, the user may apply the image through the display unit and the sound through the ear cup.

In an embodiment, the headset may be driven in a manner in which the display unit overlapped with the head band is positioned in front of the user's eye in a semi-automatic manner if the click module is introduced and the button is pressed.

The embodiments proposed in the present invention can solve the problem that the user is friendly and the display lens-part is touched with the hand to contaminate the field of view, or the user has difficulty detached from the originally worn position to the ear cap or the head band part while lowering the display unit fixed to the head with the hand.

By introducing the concept proposed in the present invention, various problems of form factors that have been limited in commercialization in the related art can be solved always using a simple method that is not complicated.

### BRIEF DESCRIPTION OF THE DRAWINGS

FIG. 1 is a diagram illustrating a first use state of a headset including a rotatable display unit according to an embodiment.

FIG. 2 is a diagram illustrating a second use state of a headset including a rotatable display unit according to an embodiment.

FIG. 3 is a diagram illustrating a form of a connection unit 200 of a headset including a rotatable display unit according to an embodiment.

FIG. 4 is a diagram illustrating an internal structure of a connection unit according to the form illustrated in FIG. 3.

FIG. 5 is a diagram illustrating a connection relationship between components of a connection unit according to the form illustrated in FIG. 3 in order to illustrate a coupling structure between components of the connection unit.

FIG. 6 is a diagram illustrating another form of a connection unit 200 of a headset including a rotatable display unit according to an embodiment.

FIG. 7 is a diagram illustrating a connection relationship between components of a connection unit according to the other form illustrated in FIG. 6 in order to illustrate a coupling structure between components of the connection unit.

FIG. 8 is a diagram illustrating a connection relationship between components of a connection unit according to the other form illustrated in FIG. 6 in order to illustrate a coupling structure between components of the connection unit.

FIG. 9 is a diagram illustrating a form in which each component sequentially operates when a button of a click module is pressed in a connection unit according to the other form illustrated in FIG. 6.

FIG. 10 is a diagram illustrating a form in which a display band is elevated and then descend in a way that the button of a click module is pressed in a connection unit according to the other form illustrated in FIG. 6.

FIG. 11 is a diagram showing the structure of a rotation module of a headset including a rotatable display unit according to another embodiment.

FIG. 12 is a diagram showing the internal structure of the rotation module of a headset including a rotatable display unit according to another embodiment and its assembly steps.

FIG. 13 is a diagram showing a situation where the length adjustment part of the display band in a headset including a rotatable display unit according to another embodiment is caught by a stopper, limiting the rotation radius.

FIG. 14 is a diagram showing a second usage state of a headset including a rotatable display unit according to another embodiment.

### DETAILED DESCRIPTION

Hereinafter, embodiments will be described in detail with reference to the accompanying drawings. However, various changes may be made to the embodiments so that the scope of the patent application is not limited or limited by these embodiments. It should be understood that all changes, equivalents, and alternatives to the embodiments are included in the scope of the present disclosure.

The terminology used in the embodiment is used for the purpose of description only and should not be construed as a limiting intention. The singular forms include plural forms unless the context clearly dictates otherwise. In this specification, it should be understood that the terms such as “include” or “have” are intended to designate the presence of features, numbers, steps, operations, components, components, or combinations thereof described in the specification, and do not preclude the presence or addition of one or more other features, numbers, steps, operations, components, components, or combinations thereof.

Unless otherwise defined, all terms used herein, including technical or scientific terms, have the same meaning as commonly understood by one of ordinary skill in the art to which the embodiment belongs. Terms such as those defined in commonly used dictionaries should be interpreted as having a meaning that is consistent with the meaning in the context of the relevant art, and are not interpreted in an idealized or overly formal sense unless expressly so defined in this application.

In addition, in the description with reference to the accompanying drawings, the same components are assigned the same reference numerals regardless of the drawing numerals, and duplicate descriptions thereof will be omitted. In the description of the embodiment, a detailed description of related known technologies is omitted when it is determined that the subject matter of the embodiment may be unnecessarily obscured.

In addition, in the description of the components of the embodiment, terms such as first, second, A, B, (a), and (b) may be used. These terms are only for distinguishing the components from other components, and the nature, order, or order of the corresponding components is not limited by the terms. It should be understood that when an element is described as being “connected,” “coupled,” or “connected” to another component, the element may be directly connected or connected to the other component, but another component may be “connected,” “coupled,” or “connected” between each component.

The components included in one embodiment and the components including common functions will be described using the same name in other embodiments. Unless otherwise noted, the descriptions described in one embodiment may be applied to other embodiments, and detailed descriptions will be omitted in duplicate.

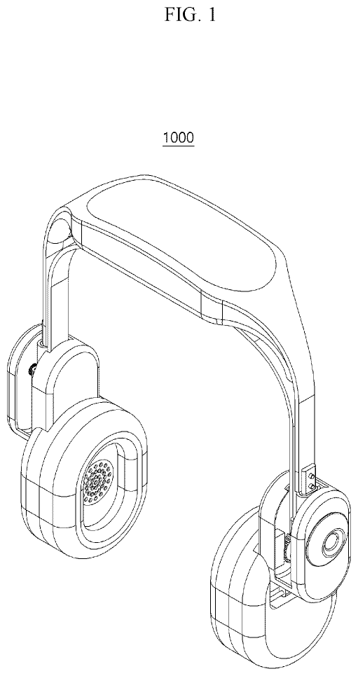

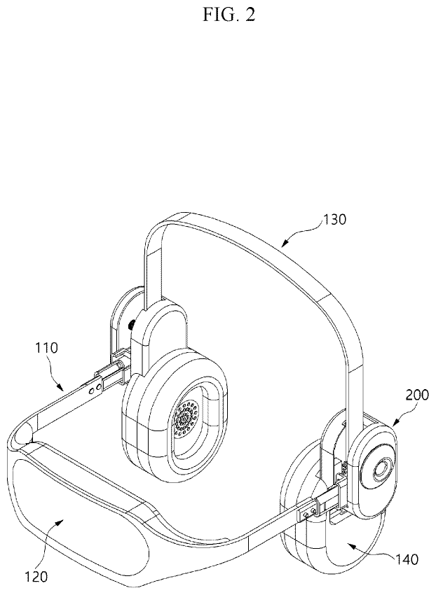

FIG. 1 is a diagram showing a first use state of a headset rotatable display unit according to an embodiment. Also, FIG. 2 is a diagram showing a second use state of a headset rotatable display unit according to an embodiment.

Hereinafter, the structure of the headset including the rotatable display unit proposed in the present invention, the driving method of each component, and the use method thereof will be described in detail with reference to FIGS. 1 and 2.

A headset including a rotatable display unit according to an embodiment of the present invention may be a headband and an ear cap connected to both ends of the headband through a connection unit; a display unit mounted on a display band connected from the connection unit; and the display band may be rotatable from a first position where the display unit overlaps with the headband by axes of the connection unit to a second position located in front of a user's eye.

Referring to FIG. 1, the headset may have a head band 130 including an ear cap 140 at both ends and may have a display band 110 equipped with a display 120 to overlap with the head band on the outer side of the head band (which is located far away from the user's head) in a first use state. In this way, when the display unit is not used, the display unit may overlap the head band.

The earcap may not be a fixed structure in the headband for user convenience, but may include a rotating portion in a portion connected to the headband to change the angle connected to the headband of the earcap. The ear cap may include a touch sensor or button to strengthen the user's UI convenience on the outer surface of the ear cap or the inside of the outer cover as necessary. The touch sensor or button may transmit a signal according to the user's intention when the headset operates in interoperation with an external electronic device.

The ear cap may include a charging port or a battery unit. The display band of the headset rotates mechanically, but it may require power connection to drive the display of the display unit. In this case, in one example, a battery may be mounted inside the ear cap or a connection terminal with an external power may be provided in the ear cap to supply electricity.

The head band may include a length adjuster that can adjust the length according to the size of the user's head.

Referring to FIG. 2, in the second use state, the display band rotates toward the front of the user and is positioned in front of the user's eyes. In the second use state, the user can view the image through the display unit.

Although FIGS. 1 and 2 illustrate the display band located outside the head band in one form, the display band located inside the head band is also included in the technical idea of the present invention.

In this case, it may be more preferable that the display band is located outside the head band. This is because if the head band is positioned inside, it can be stably positioned despite the rotation of the display band by being closely attached to the head of the user. In addition, when the display band is positioned inside the head band, a problem may occur in that the user's hair stains the inner lens of the display band or continuously sweeps the user's hair during the pivotal motion of the display band.

The display of the display band may form a structure that is somewhat spaced apart from the outside of the headband. Through this, lens protection and smooth pivoting motion of the display unit may be enabled, and when rotating, the lens of the display unit may be properly positioned in front of the user's eyes.

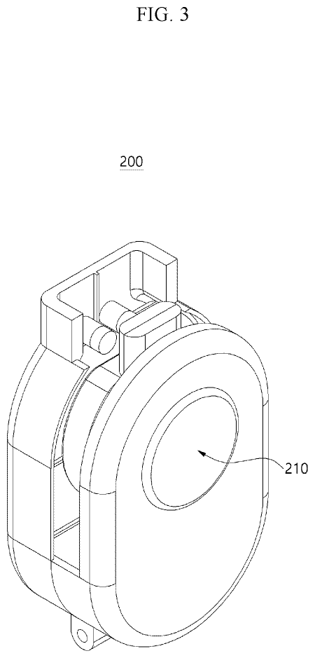

FIG. 3 is a diagram illustrating a form of a connection unit 200 of a headset including a rotatable display unit according to an embodiment.

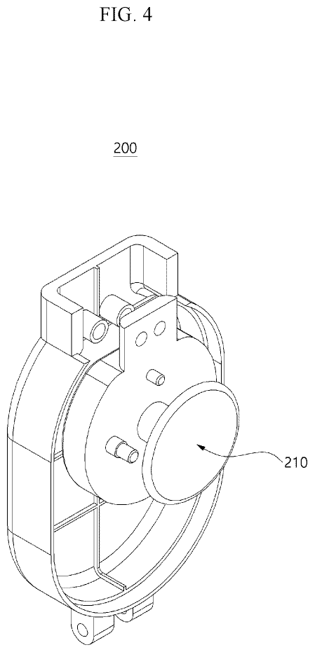

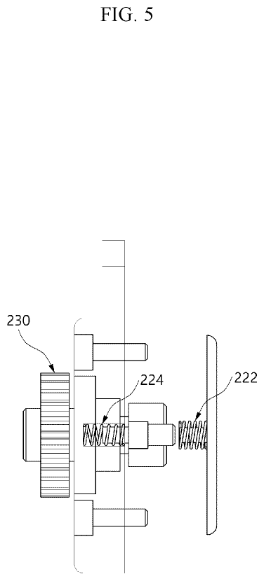

FIG. 4 is a diagram illustrating an internal structure of a connection unit according to the form illustrated in FIG. 3, and FIG. 5 is a diagram illustrating a connection relationship between components of a connection unit according to the form illustrated in FIG. 3 in order to illustrate a coupling structure between components of the connection unit.

FIGS. 3 to 5 are one examples designed to allow the pivoting motion of the display band due to the elasticity of the spring when the button of the click module located in the connection unit is pressed.

According to an embodiment, the connection unit may include a click module, and the pivoting may be semi-automatically performed when the button of the click module located in the connection unit is pressed.

According to an embodiment, the connection unit may include at least one shaft extending in a third direction vertically to the button from the center of the button; a pinion gear mounted on one end of the extended shaft; a mainspring mounted together on the extended shaft adjacent to the pinion gear; and a spring provided to be compressible in the third direction along the shaft between the button and the pinion gear.

The click module may include a button that may enter the inside located at the center of the connection unit. As illustrated in FIG. 5, the button of the click module may be disposed vertically to one end of the shaft where the first spring 222 and the second spring 224 are mounted. A pinion gear 230 that helps the pivoting motion may be mounted at the other end of the shaft. In an example, the button of the click module may be disposed parallel to the pinion gear.

The mainspring may be disposed on the same shaft adjacent to the pinion gear. The pinion gear may be rotated together by using the force that the mainspring is unwinding, and the display band may be rotated through it.

The semi-automatic pivoting motion may be a pivoting motion using a physical structure of a machinery that does not introduce electronic means. The connection unit of the headset proposed in the above embodiment is designed to allow the semi-automatic pivoting motion by devising a simple mechanical device without introducing complex means that use separate power from the inside and outside. Here, semi-automatic refers to the motion in which the display band pivots by itself when the user acts to press the button of the click module. In this case, the semi-automatic pivot may use the force that rotates by the mainspring is unwinding as the force that falls the display band. Of course, when the user lowers the display band in a standing position, gravity may additionally affect the pivoting.

While the pivoting from the first position to the second position is realized semi-automatically, the display band returns from the second position to the first position may be driven manually.

According to an embodiment, the connection unit may further include a deceleration unit 270 that decelerates when the display band approaches the second position after the rotation starts, and the deceleration unit may be engaged with the pinion gear.

Through the deceleration unit, the display unit having a weight during the rotation motion may be driven so as not to impact the user. The deceleration unit may also be provided using only a physical structure of a gear without any electromagnetic means introduced.

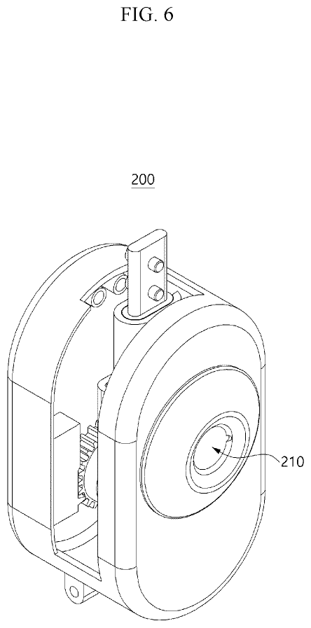

In FIGS. 6 to 10, a headset according to an embodiment of rotating in another manner is disclosed. The structure disclosed in FIGS. 6 to 10 does not operate in a manner in which the display unit directly rotates when simply pressing a button of the click module. The headset of the structure disclosed in FIGS. 6 to 10 is stretched first in a direction away from the head of the user (the vertical upward direction according to one example) when pressing a button of the click module, and then driven to rotate in front of the user's eyes by a unwinding of the mainspring after being sufficiently stretched.

According to an embodiment, even in the manner of rotating after stretching, the headset may include no electromagnetic means and may present a headset that is driven only by the introduction of physical and mechanical components.

FIG. 6 is a diagram illustrating another form of a connection unit 200 of a headset including a rotatable display unit according to an embodiment.

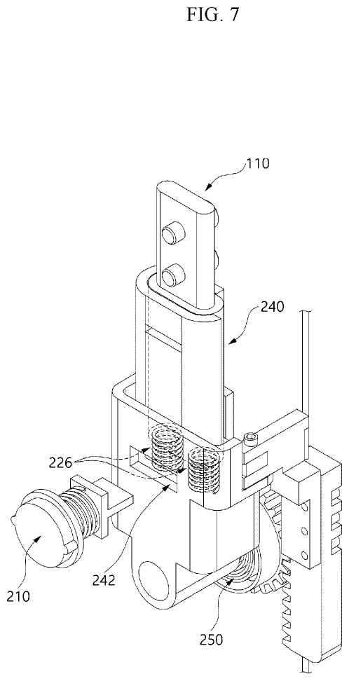

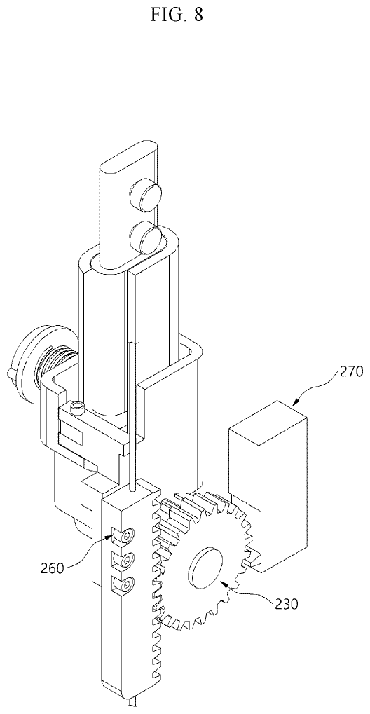

In FIGS. 7 and 8, a connection relationship between components of the headset connection unit that can be driven to rotate after stretching is disclosed. FIG. 7 is a diagram illustrating a connection relationship of each component viewed from one side to illustrate a coupling structure between components of the connection unit according to another form illustrated in FIG. 6, and FIG. 8 is a diagram illustrating a connection relationship of each component viewed from the other side to illustrate a coupling structure between components of the connection unit according to another form illustrated in FIG. 6.

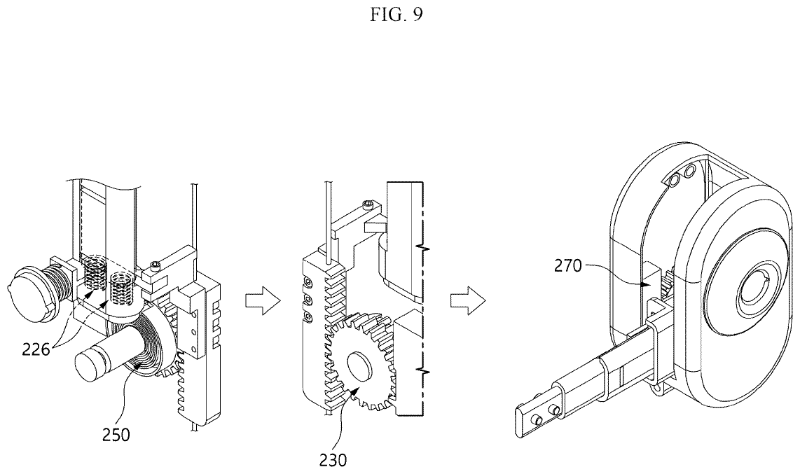

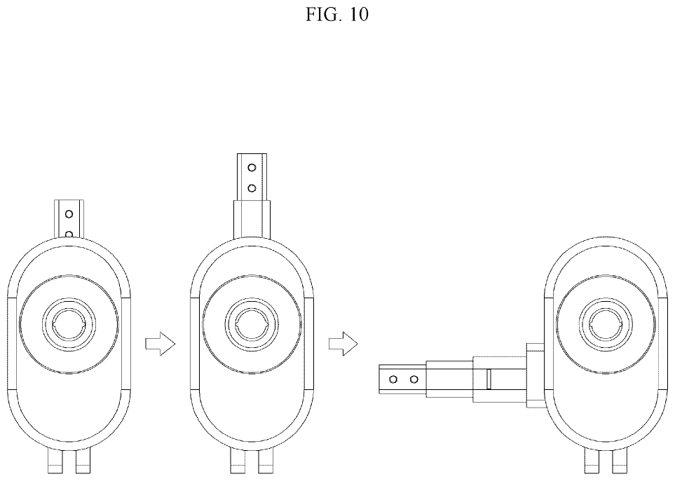

In FIGS. 9 and 10, positions and movements of each stage of components of the headset connection unit that can be driven to rotate after stretching are disclosed. FIG. 9 is a diagram illustrating a form in which each component sequentially operates when a button of a click module is pressed in the connection unit according to another form illustrated in FIG. 6, and FIG. 10 is a diagram illustrating a form in which the display band elevates and then descends when a button of a click module is pressed in the connection unit according to another form illustrated in FIG. 6.

According to an embodiment, the rotation may be performed after the display band is stretched in a direction away from the head of the user.

To enable such stretching, the display band may introduce a shaft 240 into a shoe with the connection unit.

According to an embodiment, the display band may have a structure extending from the shaft 240 mounted on the connection unit, and the stretching may be performed by vertically elevating from the connection unit 220 when pressing the button. In this case, the stretching may elevate from several millimeters to several tens millimeters. The height may preferably elevate in the range of 5 mm to 20 mm in consideration of the size of the user's face.

In addition, according to an embodiment, the connection unit may include a spring (third spring, 226) provided at the other end on which the display band of the shaft is located, and when the button is pressed, the shaft may be vertically elevated by the elastic force of the spring.

In order for the shaft to elevate vertically, in one example, the display band and the shaft are attached, and the shaft may introduce springs, rack gears, vertical gears, and pinion gears that engage the vertical gears so that they elevate when the buttons of the click module are pressed. In addition, in an embodiment, it may further include a mainspring having the same rotation axis as the pinion gear. If the mainspring is used, the rotation force of the pinion gear may be increased while the mainspring is unwound when the shaft is vertically elevated.

If the button of the click module is pressed, the shaft fixed to the shaft groove is dropped and the display band is vertically elevated by the force of the third spring. From the middle figure of FIG. 9, it can be confirmed that the vertical gear attached to the shaft is elevating by the elasticity of the spring. In this case, the pinion gear connected to the vertical gear rotates, and the rotational force of the pinion gear is increased by the unwinding of the mainspring having the same axis as the pinion gear.

According to an embodiment, the connection unit may further include a deceleration unit 270 in which the other side of the pinion gear 230 is engaged, and the deceleration unit may adjust a falling speed during a pivotal motion of the display band. This is also to prevent the user from affecting the headband wearing state despite the rotation according to the weight of the display unit, as in the previous embodiment.

Looking at the right side of FIG. 9, it can be seen that the display band and the shaft rotated at 90 degrees by the unwinding of the mainspring after the vertical gear has fully elevated. In this case, in the rotation motion process, the deceleration unit that is in contact with the other side of the pinion gear serves to reduce the falling speed of the display band.

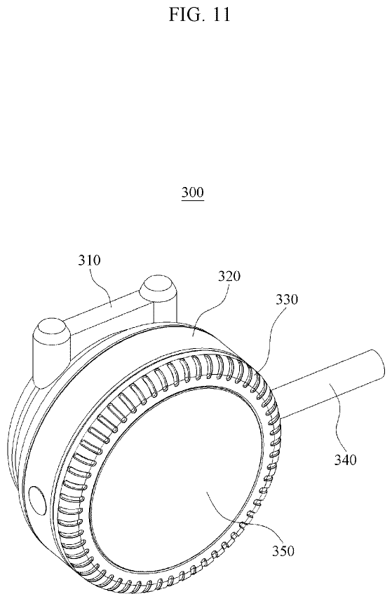

Hereinafter, the structure of the headset module including the rotatable display unit according to another embodiment will be described in detail with reference to FIGS. 11 to 14.

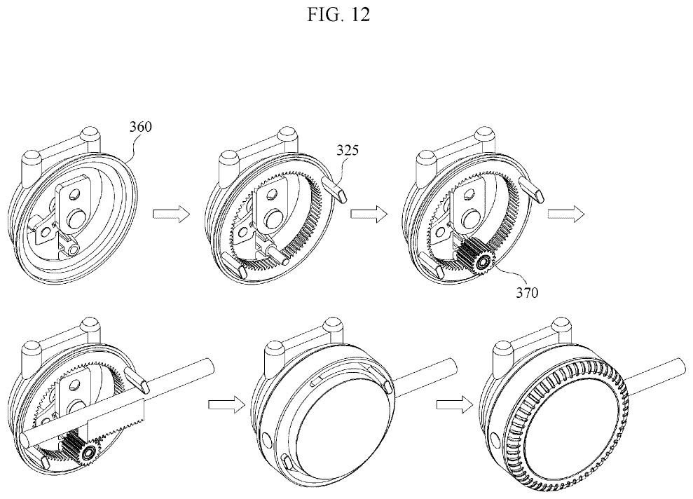

FIG. 11 illustrates the structure of the rotation module of the headset including the rotatable display unit according to another embodiment, and FIG. 12 illustrates the internal structure of the rotation module of the headset including the rotatable display unit and the step stages thereof according to another embodiment.

The headset according to another embodiment may include an electronic module formed on the outer surface of the headset's earband.

A headset including a rotatable display unit according to another embodiment of the present invention comprises: a headband and an earband connected to both ends of the headband; a rotation module located on the surface of the earband; and a display unit mounted on a display band connected to the rotation module, wherein the display band is configured to rotate the display unit from a first position, where it overlaps with the headband, to a second position, where it is located in front of the user's eyes, by rotating the rotation module.

According to one embodiment, the rotation module may include a gear structure for rotational movement and a stopper for limiting the rotation radius.

According to one embodiment, the rotation module may include a length adjustment unit of the display band in a bar structure extended in one direction.

According to one embodiment, the display band rotates along with the length adjustment unit of the display band in the bar structure during rotational movement, and the bar structure may apply a limit to the rotation radius of the display band by being caught on the stopper.

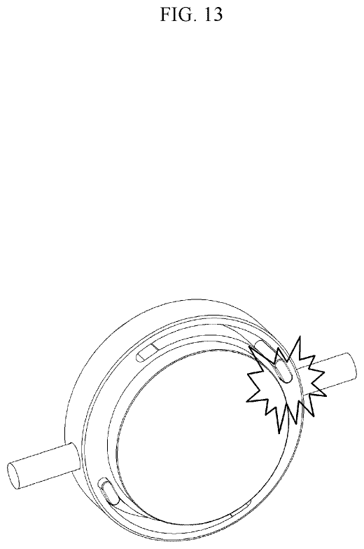

FIG. 13 illustrates a situation in which the length adjustment unit of the display band of a headset including a rotatable display bar is restricted in its rotation radius by being caught on a stopper. In this case, the stopper may be formed as a protruded embossed structure and may limit the rotation radius by engaging in a flat structure during the rotation of the bar structure.

The rotation module may include a rotation module housing, a hinge mounted inside the housing, a rotation external gear, a rotation internal gear, a housing cover with a protruding stopper, and other assembled components of the rotational driving mechanism. In one example, the rotation module housing may be designed to rotate together with the rotation module during rotation, while in another example, the rotation module housing may be fixed to the display band, allowing only the rotational driving mechanism to rotate.

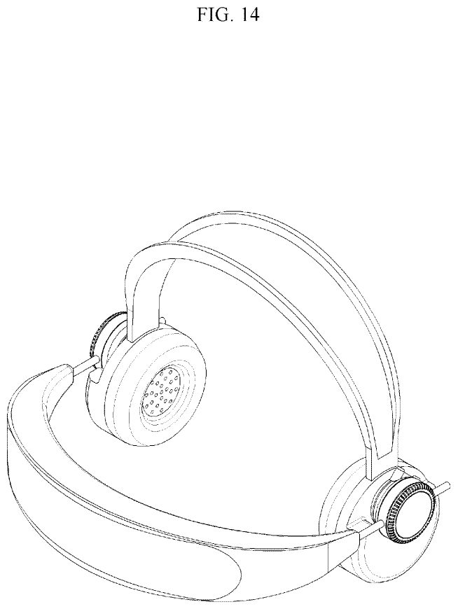

FIG. 14 illustrates a second usage state of the headset including a rotatable display unit according to another embodiment.

According to another embodiment of the present invention, a method of using a headset including a rotatable display unit, in which the headset includes a display unit, the headset includes a headband and an ear cap connected to both ends of the headband through a connection unit. The display may include a display mounted on a display band connected from the connection unit, and when a user wants to view an image through the display, when pressing a button of a click module located at the connection unit, the display band may rotate from a first position where the display overlaps with the head band to a second position where the user is located in front of the eye.

The headset including the rotatable display unit may be a headset according to an embodiment of the present invention.

According to the method of using the headset, when the headset is rotated from the second position to the first position, the user may move the display band to the first position with his hand.

The pivoting motion of the headset is not any electromagnetic means and only operates by driving physical or mechanical parts.

Although the embodiments have been described above by the limited drawings, those skilled in the art can apply various technical modifications and variations based on the above. For example, appropriate results can be achieved even if the described techniques are performed in a different order from the described method, and/or the components such as the described system, structure, apparatus, and circuit are combined or combined in a different form from the described method, or replaced or substituted by other components or equivalents.

Therefore, other implementations, other embodiments, and equivalents to the claims are also within the scope of the claims described below.

### DESCRIPTION OF THE SYMBOLS

1000 headset
110 display band
120 display unit
130 headband
140 ear cap
200 connection unit
210 click module
222 first spring
224 second spring
226 third spring
230 pinion gear
240 shaft
242 shaft groove
250 mainspring
260 rack gear
270 deceleration unit

What is claimed is:

1. A headset comprising: an ear cap connected to both ends of the head band and the head band through a connection unit; a display unit mounted on a display band connected from the connection unit; and the display band is rotatable from a first position where the display unit overlaps with the head band around the connection unit to a second position where the display band is positioned in front of a user's eye.

2. The headset of claim 1, wherein the connection unit comprises a click module, and the rotation is semi-automatically performed by pressing a button of the click module positioned at the connection unit.

3. The headset of claim 2, wherein the connection unit further comprises mainspring, and the rotation is by using a force that rotates by unwinding the mainspring.

4. The headset of claim 2, wherein the display band is manually driven from the second position to the first position.

5. The headset of claim 2, wherein the connection unit includes at least one of an axis extending in a third direction vertically to the button from the center of the button; a pinion gear mounted at one end of the extended axis; a mainspring mounted together at the extended axis adjacent to the pinion gear; and a spring provided in the third direction to be compressed along the axis between the button and the pinion gear.

6. The headset of claim 5, wherein the connection unit further comprises a reduction unit that decelerates when the display band approaches the second position after the rotation starts, and the reduction unit is engaged with the pinion gear.

7. The headset of claim 2, wherein the rotation is performed according that the display band extends away from the head of the user.

8. The headset of claim 7, wherein the display band is configured to extend from a shaft mounted at the connection unit, and the extension is vertically elevated by the shaft at the connection unit when the button is pressed.

9. The headset of claim 8, wherein the connection unit comprises a spring provided at the other end where the display band of the shaft is positioned, and the shaft is vertically elevated by the elastic force of the spring when the button is pressed.

10. The headset of claim 8, wherein the connection unit further comprises a vertical gear coupled to the shaft; a pinion gear rotating by engaging one side with the vertical gear; and a mainspring sharing the same rotational axis as the pinion gear; and wherein the rotational force of the pinion gear increases as the mainspring unwinds when the shaft vertically ascends.

11. The headset of claim 10, wherein the connection unit further comprises a reduction unit engaged at the other side of the pinion gear, and the reduction unit adjusts a falling speed when the display band is rotating.

12. A method of using a headset including a display unit, the headset comprising: an ear cap connected to both ends of a head band and the head band through a connection unit; and a display unit mounted on a display band connected to the connection unit, wherein when a user wants to view an image through the display unit, when a button positioned at the connection unit is pressed, the display band rotates from a first position where the display unit overlaps with the head band along the connection unit to a second position where the display unit is positioned in front of a user's eye.
